(19) United States
(12) Patent Application Publication
(10) Pub. No.: US 2022/0136766 A1
(43) Pub. Date: May 5, 2022

(54) Smart Refrigerator

(71) Applicant: Scott C Harris, San Diego, CA (US)

(72) Inventor: Scott C Harris, San Diego, CA (US)

(21) Appl. No.: 17/088,979

(22) Filed: Nov. 4, 2020

(51) Int. Cl. F25D 29/00; F25D 23/02

(52) U.S. Cl. CPC F25D 29/00; F25D 2400/36; F25D 2700/06; F25D 23/028

(57) ABSTRACT

A smart refrigerator system which determines a location of each item in the refrigerator, and provides information to the user about the items in the refrigerator, without opening the refrigerator door. A sensor, such as a camera, can image an area adjacent to the internal cavity of the refrigerator. A processing system uses that information about items which are being put into and removed from the refrigerator, and forms a map of items that are in the refrigerator including information about the items in the refrigerator and a location of the item in the refrigerator.

### BACKGROUND

A refrigerator keeps items cold that are inside the refrigerator. Users obtain food items, and store them in the refrigerator for later consumption

A substantial part of the energy used by a refrigerator is consumed when the refrigerator door is opened, while users look through the refrigerator for different items and remove them. Even so, items once in the refrigerator can be forgotten, and eventually they can spoil.

Refrigerator door alarms are known which create audible alarms when the refrigerator door is kept open for too long. However, a common reason for keeping the door open too long is when refrigerator is when the user is looking for something in the refrigerator or browsing through its contents.

### SUMMARY

The present application describes a smart refrigerator, which uses artificial intelligence to form, and keep updated, a database of different items that are being stored in the refrigerator. That database is updated with additional information whenever an item is moved, and can also be updated based on other information to form a smart map of different items that are in the refrigerator.

That map can be used to show information about what is in the refrigerator to the user, without the user having to open the refrigerator door in order to find out what is in the refrigerator.

The map can also be used with an artificial intelligence assistant to get information about what is in the refrigerator, by asking the assistant, questions such as “what wine do I have cold” or “what meals do I have that are easy to make”.

The map can also be annotated with information about suggested expiration times, allowing the assistant to ask questions such as “what do I have that's about to go bad”.

Additional information can be added to the database about items that are not in the refrigerator, such as items in a pantry, using an external camera.

### BRIEF DESCRIPTION OF THE DRAWINGS

These and other aspects will now be described with reference to the accompanying drawings wherein:

FIG. 1 shows a smart refrigerator;

FIG. 2 shows a block diagram of the smart refrigerator and the different parts as connected with an external cellular phone;

FIG. 3 shows a flowchart of operation of creating the map of items in the refrigerator;

FIG. 4 shows an annotate routine which determines additional information about the items in the refrigerator that can be used to find information about the mapped items; and

FIG. 5 shows a flowchart of refrigerator operations.

### DETAILED DESCRIPTION

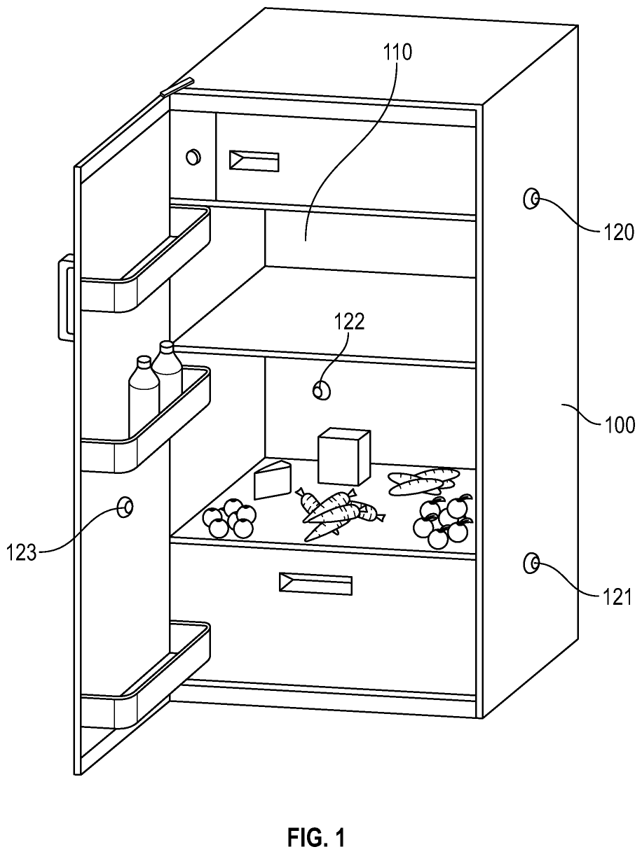

An embodiment of the refrigerator of an embodiment shown in FIG. 1. The smart refrigerator 100 includes an interior space 110 which is continually monitored by sensors to find items being inserted and removed from the interior space. The sensors can be a number of different cameras shown generally as 120, 121, 122, 123. It should be understood that cameras can be located in different locations within the refrigerator in order to attempt to image all different surfaces within the refrigerator. The cameras can be built-in cameras, or can be stand-alone cameras which can be placed into the refrigerator compartment and have wireless capabilities.

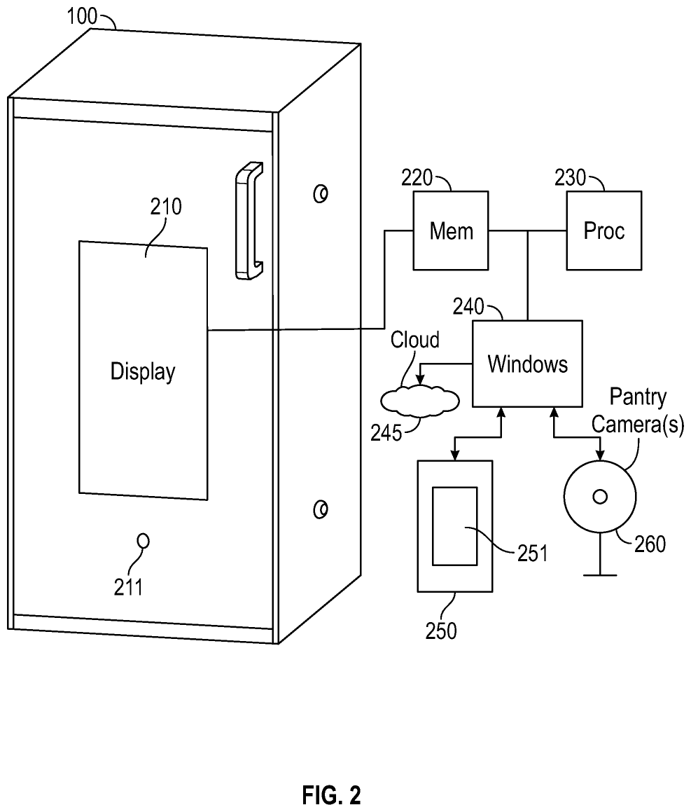

FIG. 2 shows an electronic block diagram of the refrigerator. The refrigerator 100 is shown in the closed position. The outside of the refrigerator 100 may include a display 210. The display is driven by a memory 220 and processor 230 which may also include a display driver. The memory 220 stores a map of all the information that is obtained through the processing by the processor 230 as described herein. The map is a table showing information about the items, as described herein. A wireless communication device 240 which can be Bluetooth or Wi-Fi or both, also communicates to external devices. In an embodiment, the wireless device can connect to a cloud storage and/or information device, which may store and obtain information about different items in the refrigerator. The cloud storage may store a backup of the map, and may provide a repository of information about the items that are in the refrigerator and are used as described herein.

The wireless device is also shown connected to a cellular phone 250, which can include a display 251 that can show the same display information that is shown on the display 210, or can show more targeted information. The wireless device can also be connected to auxiliary cameras 260, referred to herein as pantry cameras, which can catalog other food information.

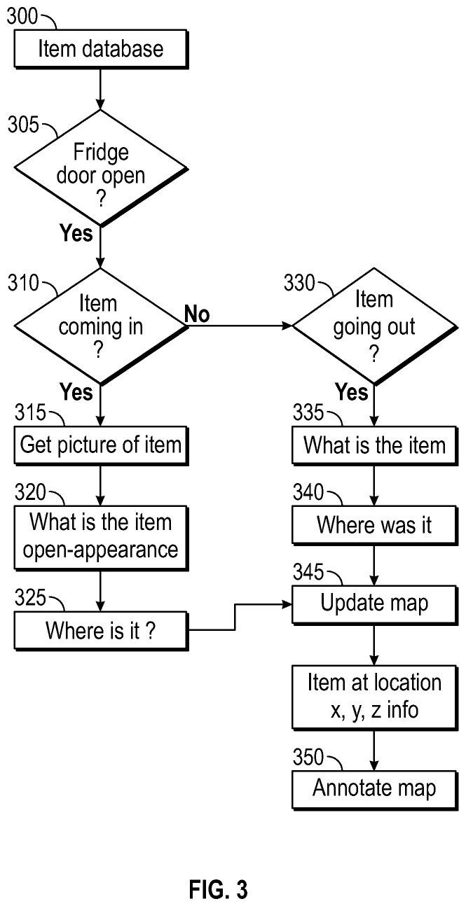

Processing of items added to and removed from the refrigerator is carried out as shown in FIG. 3. FIG. 3 shows forming and updating an item database at 300, based on specified triggers and parameters.

At 305, the system determines that the refrigerator door has been opened. When the refrigerator door is open is the only time that a user can put things into the refrigerator and take things out of the refrigerator. Accordingly, the cameras are monitored at 310 to determine if an item is coming into the refrigerator at 310.

If an item is coming into the refrigerator, the camera gets a picture of that item at 315. Based on the picture of the item at 315, the system processes the item to determine information about the item. At 320. The additional information can be determined in many different ways. An embodiment can analyze the photo of the item and correlate that with a database of photos about food items obtained on the cloud 245. This data has photos of different appearances of different items that are obtained from different grocery stores. For example, a typical grocery store may have 40,000 different items in the grocery store. Photos of the packages of all of those items, for all grocery stores in the area of the user, can be stored in the cloud. When a user is putting an item into the refrigerator, 320 detects which of the items in the grocery store this is. For packaged food, this may compare the look of the packaging against a database of package looks. For bulk food, such as meat, vegetables, and other unpackaged items, the system uses artificial intelligence to try to determine what kind of packaged item this is, is it for example ground beef, lettuce, or other kinds of vegetables, based on the image it obtains.

The user can facilitate this recognition by placing the UPC code adjacent to one of the cameras in order to allow the camera to image that UPC code and thereby use that to access the memory.

The user can also facilitate this by imaging the label from a bulk item, for example the label on a meat package, or by imaging the actual vegetables themselves by putting them up to the camera.

In another embodiment, the user can also talk to the refrigerator, (or to the app running on the phone, to tell the refrigerator more specifics about what is putting in the refrigerator. For example, when the user puts in a package of meat, the user can say “this is a 2 pound package of ground beef”.

In another embodiment, the sensors can be tag readers that can read wireless tags, such as RFID tags, from the items as they are put into the refrigerator. More generally, the sensors can read product codes from the products.

For many of these items, the system determines the item being put into the refrigerator. At 325, the system determines where the item is being put, that is specifically where in 3 dimensional space in the refrigerator the item has been placed.

All of the information is used to update the map at 345, to represent information about the item, and information about the location in 3 dimensional space where the item has been located in the refrigerator.

If an item is not coming in to the refrigerator at 310, then 330 detects an item going out of the refrigerator. 335 uses a picture of the item and/or the location where the item was being stored (in three-dimensional space) at 340 to determine which item in the map is going out of the refrigerator. Items that are removed from the refrigerator are deleted from the map, and again the map is updated at 345.

The update of the map provides for each item, information about the item (to the extent that information could be determined, and otherwise provides that the item is an unknown item as described herein) and the location at the item in three-dimensional space such as location x,y,z. As an alternative to an x,y,z 3-dimensional coordinate system, any other coordinate system can be used to describe the location of the item. For example, the item can be located according to a shelf based coordinate system, where each shelf has its own coordinate system. In this shelf based coordinate system, the coordinate may be for example shelf 2 (second shelf from the bottom), center quadrant, top item on a stack of items that includes 2 items under this item. This forms an update of the map.

At 350, the map is annotated to include additional information about the items. As described herein, this information can include, for example, probable or actual expiration dates for the items.

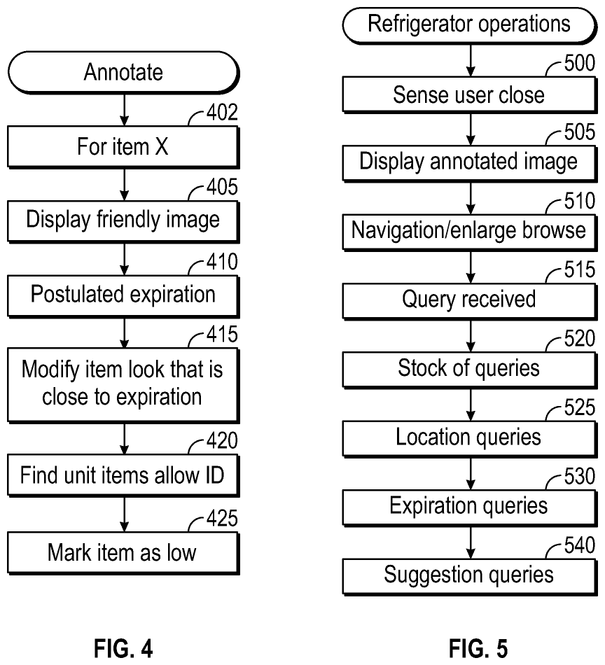

FIG. 4 illustrates the annotate routine which is carried out on the items in the refrigerator to update and refine information in the map. The annotate can be carried out every specified amount of time, or any time access to the information is requested or each time the door is opened or the app accessed, or the user comes close to the refrigerator, for example.

Each item in the refrigerator is identified by an identifier while in the refrigerator. The identifier can be for example a unique identifier, such as a number of the item, or can be based on the location of the item in the refrigerator using some coordinate system. The annotate routine finds information about a given item x at 402. This may be done only one time for each item, or may be done other times.

At 405, a display friendly image of the item is obtained for displaying on the screen to the user. For example, an actual photo of an item may not display in a way that makes it easy to determine at a glance, what the item is. It may be better to show for example an item modified to display its contents more clearly to a viewer of the screen.

Display friendly images can include, for example cartoonized images, or images which have been modified to include enhanced description of the contents of the package. For example, a box of mushrooms could be labeled as “mushrooms”, or could just show a single mushroom on the outside, instead of just showing the mushroom box. The display friendly image is any image that can be displayed on a small screen display, and will allow the user to more easily understand what the item represents, as compared with the actual container of the product.

At 410, a postulated expiration for the item is obtained. This postulated expiration can for example use the real expiration date if that can be read from the item, or the AI client can postulate an expiration date based on finding information about the item. For each of the items, the system can postulate how long the item will stay good in the refrigerator. For example, a box of mushrooms may stay good for 5 days. Half-and-half of a certain brand may stay good for 10 days. Items such as canned goods, (if kept in the refrigerator) or wine or beer, may have indefinite expiration dates. A postulated expiration is associated with items at 410.

At 415, items which are believed to be close to their postulated expiration may be modified in color, for example an item that is close to expiration may be modified to have a yellow highlighting to it, or items that are likely to be expired or almost expired may be shown in red.

No matter how much monitoring one does, it is believed that it will be inevitable that there will always be items in the refrigerator that have not been properly identified, either because it's they could not be identified when they were first inserted, or they were somehow moved after insertion, and cannot be imaged by the camera. Items which cannot be identified may be found during the annotation routine at 420, which tries to find unidentified items. These unidentified items will be shown in a special way on the map, for example they may be shown as a black item, or with an “x” or in some way. The user may be given the opportunity to further identify these items. For example, if a user wants to identify unidentified item at 420, the user can the user can pick up the item and place it near a camera so that it can be properly imaged, allow its UPC code to be imaged by a camera. The same actions can be taken from the user's portable phone, either allow the user to image the item or allow the user to image the UPC code. This can update the database to include the information about the item, and can update the images of the inside of the refrigerator.

Based on the map, and the information in the map, the smart refrigerator can provide information assisting the user in managing the items in their refrigerator. In one embodiment, for example, when the user places their hand on the handle, the display screen 210 on the refrigerator lights up the message “are you sure you want to open the refrigerator?, I can show you what's inside it”. In another embodiment, when the user comes close to the refrigerator, a sensor 211 senses the user's closeness, and automatically displays an image of the modified inside of the refrigerator, modified to change the items to display friendly images of the items, to the user.

Another operation that be carried out at 425 allows the user to mark an item as being low. For example, a carton of milk, a bottle of pickles, or any other item could be marked as almost out. In this way, the database can be annotated to show that the user is almost out of some item. The app running on the phone can notify the user to try to purchase these items, when in the grocery store or when buying items from an online retailer.

FIG. 5 illustrates the different operations that can be carried out by the refrigerator processing.

At 500, the sensor senses that the user is close to the refrigerator. This may immediately bring up the display warning described above, and/or cause the refrigerator to display the annotated image of the inside on either or both of the display screen 210 or the user's cellular phone display screen 251 which may automatically pop open an image when the user gets close to the refrigerator. The user can use conventional techniques such as navigation and enlargement techniques at 510 to allow increasing any part of any image size that is being shown to the user.

In this way the user can see what is inside the refrigerator, navigate to different parts of the refrigerator, and enlarge the areas being looked at without opening the refrigerator. This operation results browsing the refrigerator insides without opening the refrigerator door. With a perfect map, the user can browse everything in the refrigerator without ever opening the refrigerator door. The amount by which the user can do the browsing will depend on the accuracy of the map.

At any time, the user can also enter a query, shown at 515. The query uses artificial intelligence techniques, e.g. available on the cloud, along with the map, to try and answer questions about what can be done with the items in the refrigerator. The query can use artificial intelligence techniques to understand the language of the query, and then to use that against items in the database or the map to find information about the refrigerator contents. Example queries are referred to herein, although it should be understood that these are just exemplary and many other queries can be added.

One example query can refer to looking for specific items in the refrigerator. For example, if the user wants beer, the user can ask, ‘how much and what kind of beer or wine do I have cold?”. This query, for example is used with the map to determine different items of beer that are in the map.

The system may respond either orally or with a text message with a message “you have six of Guinnesses, and you have 2 bottles of Acme brand Pinot Grigio in the refrigerator”. The user can use the touchscreen to touch one of the items, to determine or to see a picture of it, including a location of where it is. By obtaining a preview of the items in the refrigerator, the user knows where to find a specific item in the refrigerator and therefore can keep the door open for less time.

Another query example is do I have any cheese? The system can then return information saying you have a package of shredded mozzarella and you have slices of Swiss cheese. Again, the user can find out further information such as where in the refrigerator this item is located, and/or how long the user has had these things.

These are referred to herein as stock queries, at 520, which indicate that you are querying the refrigerator about what specifically items you have in the refrigerator.

These can also be combined with or part of location queries at 525, where you ask the item “where is the mayonnaise” or “where is the cheese”, making it easier for the user to find these things and to keep the door open for a shorter period of time.

Expiration queries at 530 can be used to provide information to the user about things the user has that may be getting dangerously close to expiring. For example, when the user has mushrooms that have been kept in the refrigerator for 4 days, an expiration query may remind the user that they need to either use those mushrooms or they will go bad. Similar things can happen with milk, salad, and the like: the user can be reminded to use things that are about to go bad with the suggestion queries are also shown at 530.

A suggestion query at 540 may use databases of information along with the map of the actual contents of the refrigerator. For example, the user can say “I want a light lunch, what do I have?”. Based on information in the map, and different available databases, a number of different suggestions can be returned. If you ask for a light lunch, the system may return that you have salad and various kinds of vegetables. If you're just asking for just suggestions, the smart device can use the different items that are available in the refrigerator as different parts lists, and find recipes that can be used. This may also try to prioritize eating those things that have the most recent expiration.

The same techniques can be used with the pantry camera 260, to form a database of items in the pantry. The pantry items can be used along with any of these queries, but most specifically with the suggestion query to try to figure out what things can be made from parts on hand.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A smart refrigerator system, comprising:
a refrigerator, having an internal cavity;
at least one camera, imaging an area adjacent to the internal cavity of the refrigerator; and
a processing system, including a memory, obtaining images of items which are being put into and removed from the refrigerator, and forming a map of items that are in the refrigerator including information about the items in the refrigerator and locations of the items in the refrigerator.

2. The smart refrigerator system as in claim 1, wherein the processing system produces and displays an image of the items in the refrigerator without opening the refrigerator door.

3. The smart refrigerator system as in claim 2, wherein the refrigerator has a door, with a display thereon, and the image is displayed on the door.

4. The smart refrigerator system as in claim 2, wherein the processing system obtains substitute images of at least a plurality of the items are obtained, which are different than the images actually taken of the item, and where the substitute images are displayed on the image of the items in the refrigerator.

5. The smart refrigerator system as in claim 2, wherein the processing system also determines a location of each item in the refrigerator, and provides information to the user about where an item is in the refrigerator before the refrigerator door is opened.

6. The smart refrigerator system as in claim 2, wherein the processing system also finds information about an expected expiration date of an item, and notifies the user about that expected expiration date.

7. The smart refrigerator system as in claim 1, wherein the processing system accepts queries, in which the user asks about specific items, and receives information from the map indicating what specific items are located in the refrigerator.

8. The smart refrigerator system as in claim 2, further comprising accepting controls allowing the user to view different parts of the internal cavity of the refrigerator and to enlarge parts of the internal cavity of the refrigerator which are viewed.

9. A smart refrigerator system, comprising:
a table forming system, which forms a table, having information about items which are in a refrigerator; and
a display system, which displays information about the items that are in the refrigerator to the user without opening a door of the refrigerator, the display system displaying the information about the items that are in the refrigerator based on the table.

10. The system as in claim 9, wherein the table forming system monitors items being brought into the refrigerator, and items being removed from the refrigerator to form the table.

11. The system as in claim 10, wherein the table forming system uses a camera to obtain pictures of items going in the refrigerator pictures of items going out of the refrigerator.

12. The system as in claim 11, wherein the table forming system also stores mapping information including a 3 dimensional location in the refrigerator where the item has been located.

13. The system as in claim 11, where the table forming system recognizes the item from the picture.

14. The system as in claim 10, wherein the table forming system reads a product code from the item to recognize the item.

15. The system as in claim 10, wherein the table forming system uses a substitute image of the item, different than a look of the actual item, to display the information about the items that are in the refrigerator.

16. A smart refrigerator system, comprising:
a refrigerator;
at least one sensing device that detects information about items going in and out of the refrigerator;
a processing system, storing a list of items which are currently being stored in the refrigerator, based on information from the at least one sensing device; and
a display system, that displays information about items in the refrigerator, based on the list of items.

17. The smart refrigerator system as in claim 16, wherein the at least one sensing device is a camera that detects images about the items going into the refrigerator and about the items coming out of the refrigerator.

18. The smart refrigerator system as in claim 16, wherein the at least one sensing device senses information from a product code on the devices being put into and removed from the refrigerator.

19. The smart refrigerator system as in claim 16, wherein the list of items is in the form of a map that includes a location of the items.
